(19) United States
(12) Patent Application Publication
(10) Pub. No.: US 2026/0251150 A1
(43) Pub. Date: Aug. 27, 2026

(54) HIGH-SPEED PRESSURIZED IMPELLER DISK

(71) Applicant: P3 Technologies, LLC, Jupiter, FL (US)

(72) Inventors: Brandon A. Demski, Jupiter, FL (US); Robert W. Sanders, Stuart, FL (US)

(21) Appl. No.: 19/547,809

(22) Filed: Feb. 24, 2026

Related U.S. Application Data
(63) Continuation of application No. 18/772,749, filed on Jul. 15, 2024, now Pat. No. 12,584,491.
Application No. 18/772,749 is a continuation of application No. 16/866,623, filed on May 5, 2020, now Pat. No. 12,060,889.

(51) Int. Cl. F04D 29/22; F01D 5/14

(52) U.S. Cl. CPC F04D 29/2222; F01D 5/147; F05B 2240/301; F05D 2240/301; F05D 2260/941

(57) ABSTRACT

A pressurized impeller, including an axis of rotation, a hub, a forward wall including a first forward surface and a first aft surface, an aft wall including a second forward surface and a second aft surface, an axial opening, a radial opening, wherein the axial opening and the radial opening are connected within the pressurized impeller to form a plurality of fluid flow paths, and an internal pressurized cavity formed between the forward wall and the aft wall, wherein a first orifice opens into a tip of the pressurized impeller.

### CROSS-REFERENCE TO RELATED APPLICATIONS

This application is filed under 35 U.S.C. § 120 as a continuation of U.S. patent application Ser. No. 18/772,749, filed on Jul. 15, 2024, which application is a continuation of U.S. patent application Ser. No. 16/866,623, filed on May 5, 2020, now U.S. Pat. No. 12,060,889, which applications are hereby incorporated by reference in their entireties.

### FIELD

The present disclosure relates generally to pumps, compressors, and turbines, and more specifically centrifugal pump impellers and radial turbines.

### BACKGROUND

To achieve significant pressure-rise in a pump traditionally requires multiple impellers; also known as stages. This is both cost prohibitive and weight penalizing as the system part count increases with each subsequent impeller. Utilizing a single impeller to achieve the pressures that multiple impellers produce requires extremely high rotor speeds, which result in highly stressed impeller disks and blades, which ultimately limit the maximum pressure and life of the impeller. This stress is principally a function of the impeller's angular momentum which forces the mass outwards radially, creating high stress concentrations at regions where minimal movement occurs relative to the forces exerted and the adjoining geometry.

Traditional designs of high pressure-rise impellers rely on reducing the mass of the impeller disk, in turn lowering the stresses of the impeller along the disk, blades, hub, and shroud. While this weight reduction works to an extent, a point of diminishing returns is achieved where the impeller cannot support the torque and pressure exerted upon itself by the fluid it is pumping. This condition is defined as the tip speed limit of an impeller and is historically a combination of impeller material density and fluid dependent due to temperature, density, and viscosity of the acting medium on the impeller hydro surfaces.

### SUMMARY

The present disclosure is directed to one or more exemplary embodiments of a pressurized impeller.

In an exemplary embodiment, the pressurized impeller may comprise an axis of rotation, a hub, a forward wall including a first forward surface and a first aft surface, an aft wall including a second forward surface and a second aft surface, an axial opening, a radial opening, wherein the axial opening and the radial opening are connected within the pressurized impeller to form a plurality of fluid flow paths, and an internal pressurized cavity formed between the forward wall and the aft wall, wherein a first orifice opens into a tip of the pressurized impeller.

In an exemplary embodiment, a second orifice opens into at least one of the hub, the forward wall, and the aft wall. In an exemplary embodiment, the pressurized impeller further comprises one or more annular rings arranged in the internal pressurized cavity. In an exemplary embodiment, each ring of the one or more annular rings is arranged radially between and spaced apart from the tip and the hub, and extends from the aft wall to the forward wall. In an exemplary embodiment, at least one ring of the annular ring is arranged nonparallel to the axis of rotation.

In an exemplary embodiment, the pressurized impeller further comprises at least one stiffening rib arranged on at least one of the first aft surface and the second forward surface. In an exemplary embodiment, the at least one stiffening rib extends in a radially outward direction relative to the hub. In an exemplary embodiment, the at least one stiffening rib extends in a circumferential direction around the hub.

The present disclosure is directed to one or more exemplary embodiments of a pressurized impeller.

In an exemplary embodiment, the pressurized impeller may comprise a hub, a forward wall including a first forward surface and a first aft surface, an aft wall including a second forward surface and a second aft surface, an axial opening, a radial opening, wherein the axial opening and the radial opening are connected within the pressurized impeller to form a plurality of fluid flow paths, and an internal pressurized cavity formed between the forward wall and the aft wall, wherein a first orifice opens into the hub.

In an exemplary embodiment, a second orifice opens into at least one of the tip, the forward wall, and the aft wall. In an exemplary embodiment, the pressurized impeller further comprises one or more annular rings arranged in the internal pressurized cavity. In an exemplary embodiment, each ring of the one or more annular rings is arranged radially between and spaced apart from the tip and the hub, and extends from the aft wall to the forward wall. In an exemplary embodiment, at least one ring of the annular ring is arranged nonparallel to the axis of rotation.

In an exemplary embodiment, the pressurized impeller further comprises at least one stiffening rib arranged on at least one of the first aft surface and the second forward surface. In an exemplary embodiment, the at least one stiffening rib extends in a radially outward direction relative to the hub. In an exemplary embodiment, the at least one stiffening rib extends in a circumferential direction around the hub.

The present disclosure is directed to one or more exemplary embodiments of a pressurized impeller.

In an exemplary embodiment, the pressurized impeller may comprise a hub, a forward wall including a first forward surface and a first aft surface, an aft wall including a second forward surface and a second aft surface, an axial opening, a radial opening, wherein the axial opening and the radial opening are connected within the pressurized impeller to form a plurality of fluid flow paths, an internal pressurized cavity formed between the forward wall and the aft wall, and a support structure arranged in the internal pressurized cavity.

In an exemplary embodiment, the support structure comprises at least one stiffening rib arranged on at least one of the first aft surface and the second forward surface. In an exemplary embodiment, the at least one stiffening rib extends in a radially outward direction relative to the hub, or a circumferential direction around the hub. In an exemplary embodiment, the support structure comprises a beam arranged on the first aft surface proximate a leading edge of a blade of the pressurized impeller.

A centrifugal impeller that employs an internal pressurized cavity can reduce the stresses in the impeller disk, blades, shroud, and hub as the stiffness of the rotor is not compromised while weight is reduced across the component and peak stress regions are shifted across the part. This is due to the pressure acting in the same way a balloon does to support itself via pressure acting against the deflections naturally experienced under high rotor speed. The impeller can be a centrifugal pump or a radial inflow turbine. The pressurized cavity can be pressurized by a number of orifices that open into a pressurized section of the impeller, either through the hub, the aft wall, the forward wall, or the tip in order to adjust the pressure in the cavity from relatively low to relatively high. In an exemplary embodiment, the pressurized cavity can be pressurized by a number of orifices that open into a pressurized section of the impeller, for example thru the hub, the aft wall, the forward wall, and/or the tip in order to adjust the pressure in the cavity from relatively low to relatively high. The impeller can include annular rings extending between the aft wall and the forward wall through the pressurized cavity to stiffen the impeller. A plurality of beams or baffles can also be used to stiffen the impeller. Radial and tangential stiffening ribs on the aft and forward walls can also be used to stiffen the impeller.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1 is an isometric view of an embodiment of a high-speed pressurized impeller disk with the pressurized cavity of the present disclosure, and internal annular rings used to stiffen the cavity.

FIG. 2 shows a cross-sectional view of an embodiment of the high-speed pressurized impeller disk of the present disclosure without any internal support features within the cavity.

FIG. 3 is a cross-sectional view of an embodiment of the high-speed pressurized impeller disk that details the various ways in which the pressurized impeller disk of the present disclosure can be supplied or vented to the exterior of the impeller cavity through orifices.

FIG. 4 is a cross-sectional view of an embodiment of the pressurized impeller cavity of the present disclosure that contains internal annular support structures for stiffening of the disk and the aft wall.

FIG. 5 is an isometric view of an embodiment of the high-speed pressurized impeller disk of the present disclosure that utilizes an internal truss structure within the pressurized cavity to stiffen the disk and the aft wall.

FIG. 6 is an isometric view of an embodiment of the high-speed pressurized impeller disk of the present disclosure that details the use of ribs and spars for the stiffening of the disk in the pressurized impeller of the present disclosure.

### DETAILED DESCRIPTION

This application is intended to describe one or more embodiments of the present disclosure. It is to be understood that the use of absolute terms, such as “must,” “will,” and the like, as well as specific quantities, is to be construed as being applicable to one or more of such embodiments, but not necessarily to all such embodiments. As such, embodiments of the present disclosure may omit, or include a modification of, one or more features or functionalities described in the context of such absolute terms. In addition, the headings in this application are for reference purposes only and shall not in any way affect the meaning or interpretation of the present disclosure.

At the outset, it should be appreciated that like drawing numbers on different drawing views identify identical, or functionally similar, structural elements. It is to be understood that the claims are not limited to the disclosed aspects. It should be further understood that elements shown and/or described in the present disclosure are to be construed as being applicable to one or more of the embodiments disclosed herein, but not necessarily to all of the embodiments disclosed herein.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element, and a third element; or a device comprising a second element and a third element. A similar interpretation is intended when the phrase “used in at least one of:” is used herein.

The amount of pressure that an impeller can generate is limited by one principal feature, the tip speed of the impeller. As the tip speed is increased, the discharge pressure increases with the square of this velocity change. Consequently, the stresses in the impeller increase by the square of this tip speed change as well. Failure for conventional designs is limited by the life margin, wherein the stresses in the part will cause the impeller to fatigue and fracture given enough operating time. In high performance expendable systems, such as rocket engines, the life is not the issue but the maximum speed at which they can operate. In either of these cases, long life or high performance, decreasing the stress in the impeller allows for higher tip speeds, and in turn higher pressures. With the utilization of the pressurized impeller disk the same life and structural margins can be achieved in comparison to the historical designs while developing greater pressures.

The pressurized impeller disk of the present disclosure is a way to both stiffen and lighten the impeller disk. Stress in the impeller increases with speed via three main factors: 1) the increasing pressure of the fluid, 2) the torque generated on the impeller via the fluid pumping, and 3) the increasing angular momentum of the impeller. Since the pressure is a desirable outcome and the torque a byproduct of this, the only way to combat the stresses is via angular momentum. Angular momentum has two main components: velocity and weight. Since velocity is a fixed value, only weight can be addressed. By reducing the weight, the stresses can be reduced proportionally.

Historically, this is achieved by thinning the impeller disk to reduce stresses until such a point that the pressure loading and deflections overcome the stiffness imparted by the disk, resulting in an increasing stress with further thinning of the material. This is conceptually shown as a parabolic stress/weight curve with an ideal design point at the inflection for minimum stress. This approach results in an optimal design but produces high stress concentrations at principle locations in the impeller due to the planar nature of the disk. By employing an internal pressurized cavity, the weight can be shifted and reduced strategically. This allows for strain energy to be directed more controllably to create a more uniform stress profile across the entire impeller, resulting in a significantly reduced parabolic stress/weight curve and inflection point. This allows for lower stress, longer life, and higher performance impellers. This technology is not limited to just impellers for pumps either, radial inflow turbines, essentially a centrifugal pump in reverse, also benefit equivalently from this approach. Thus, for purposes of the description of the present disclosure, an impeller can be a centrifugal pump or a radial inflow turbine.

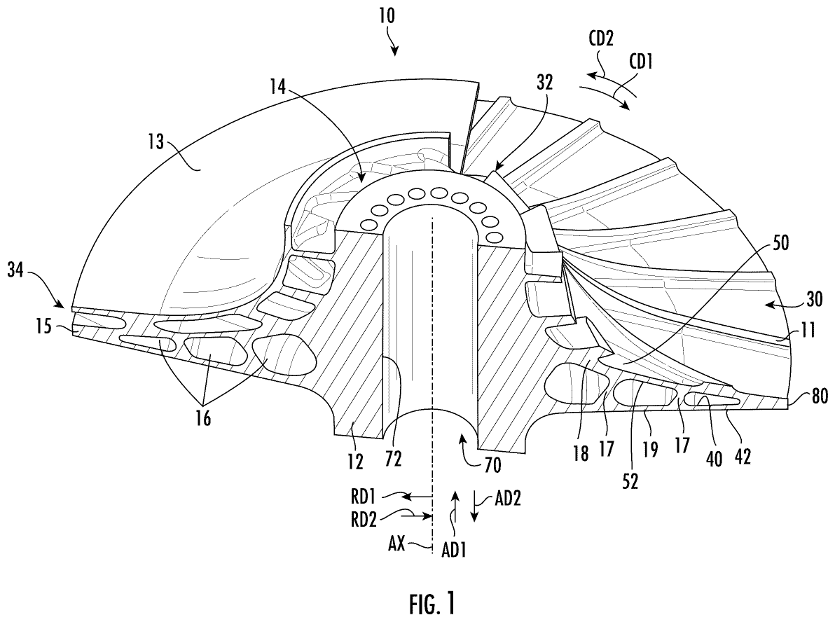

Referring now to the figures, an embodiment of pressurized impeller disk 10 is shown in FIG. 1. This is the generalized configuration of an impeller employing the technology. Pressurized impeller disk 10 comprises blades 11, which create the pressure rise, and hub 12, which attaches pressurized impeller disk 10 to the shaft. In an exemplary embodiment, pressured impeller disk 10 further comprises shroud 13, which increases impeller efficiency, and/or eye 14, which acts as the impeller inlet. In an exemplary embodiment, pressurized impeller disk 10 further comprises the tip 15 where the flow exits pressurized impeller disk 10. In a radial turbine, all of these features are the same except tip 15 becomes the inlet and eye 14 acts as the outlet. When referencing impeller orientation, there is the forward side of the impeller, the side in which eye 14 and shroud 13 reside, generally facing in axial direction AD1, and the aft side, opposite of eye 14 and shroud 13, generally facing in axial direction AD2. Pressurized impeller cavity 16 is arranged aft of blades 11, and acts as the main stress reducing and manipulating feature of the present disclosure. In an exemplary embodiment, pressurized impeller disk 10 further comprises annular ring internal support structure 17. Support structure 17 is positioned between forward cavity wall 18 and aft cavity wall 19.

Forward cavity wall 18 comprises forward facing surface 50 directed generally in axial direction AD1 and aft facing surface 52 directed generally in axial direction AD2. Blades 11 are connected to surface 50 and spaced apart circumferentially thereon, namely, in circumferential direction CD1, CD2. From eye 14, blades 11 extend in axial direction AD2, radial direction RD1, and circumferential direction CD2. Vanes 30 are formed circumferentially between blades 11 and include vane suction or inlet end 32 and vane discharge end 34. It should be appreciated that when pressurized impeller disk 10 is utilized as a radial inflow turbine the fluid flow in vanes 30 is reversed such that vanes 30 comprise vane suction or inlet end 34 and vane discharge end 32. Aft cavity wall 19 comprises forward facing surface 40 directed generally in axial direction AD1 and aft facing surface 52 directed generally in axial direction AD2.

In an exemplary embodiment, high-speed pressurized impeller disk 10 further comprises shroud 13 generally arranged proximate to forward cavity wall 18. For example, shroud 13 may be arranged on a top surface of blades 11 such that vanes 30 are formed by adjacent blades 11, shroud 13, and forward cavity wall 18. From eye 14, vanes 30 extend in axial direction AD2, radial direction RD1, and circumferential direction CD2 and form fluid flow paths.

Pressurized impeller cavity 16 is formed between forward facing surface 40, aft facing surface 52, radially outward facing surface 62, and radially inward facing surface 60. Radially outward facing surface 62 extends from forward facing surface 40 to aft facing surface 52 generally in direction AD1. Radially outward facing surface 62 is arranged proximate hub 12. In an exemplary embodiment, radially outward facing surface 62 is a curvilinear surface. Radially inward facing surface 60 extends from forward facing surface 40 to aft facing surface 52 generally in direction AD1. Radially inward facing surface 60 is arranged proximate to tip 15. In an exemplary embodiment, radially inward facing surface 60 is a curvilinear surface. In an exemplary embodiment, the length of radially inward facing surface 60 is less than the length of radially outward facing surface 62.

In an exemplary embodiment, hub 12 may comprise hole or through-hole 70 forming radially inward facing surface 72. High-speed pressurized impeller disk 10 is operatively arranged to rotate about axis AX.

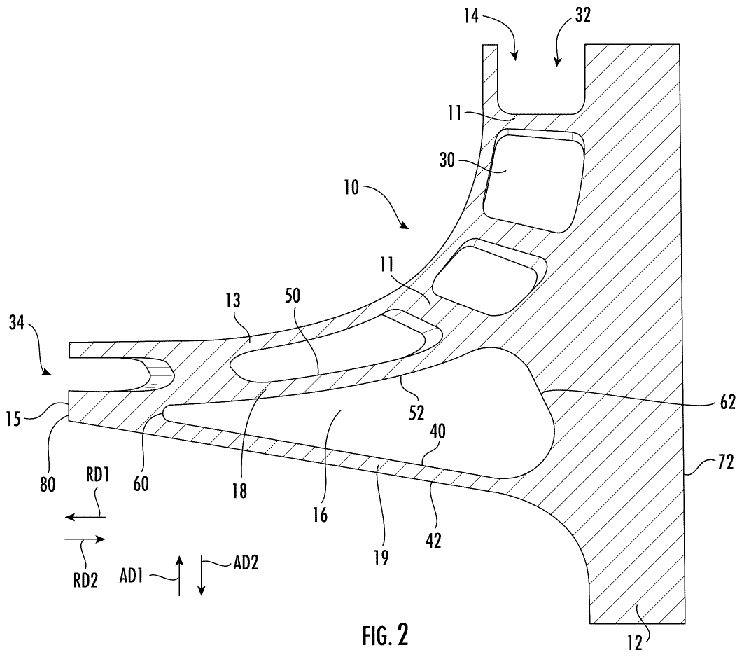

FIG. 2 is a cross-sectional view of high-speed pressurized impeller disk 10 shown in FIG. 1, without any support structure inside pressurized cavity 16. In an exemplary embodiment, cavity 16 is fully sealed. Utilizing a fully sealed cavity allows for the pocket formed by pressurized cavity 16 to be isobaric, constantly providing the stiffening independent of external forces. The pressure residing in pressurized cavity 16 can be tuned during manufacturing for structural or rotodynamic applications. Put another way, chamber 16 can be pre-pressurized during manufacturing with a pressure greater than ambient air pressure.

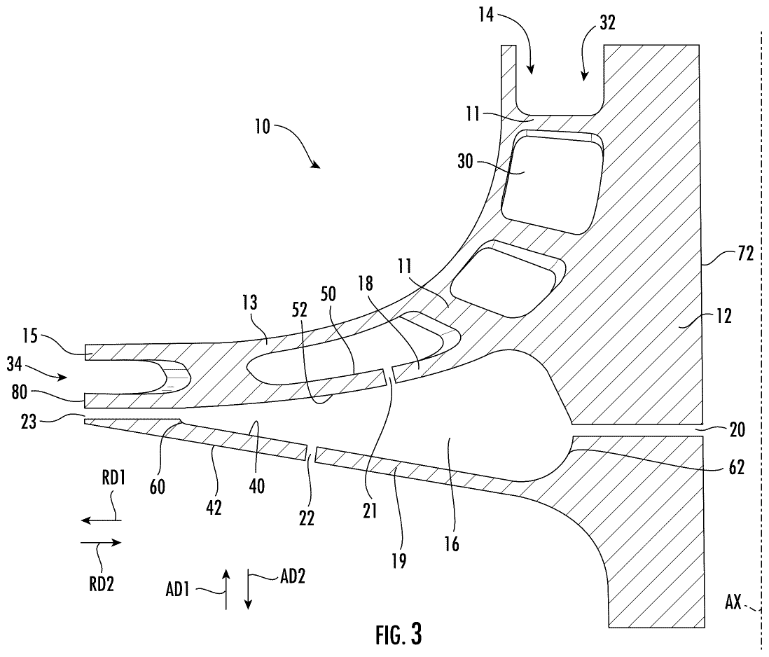

FIG. 3 is a cross-sectional view of high-speed pressurized impeller disk 10 shown in FIG. 2, further including orifices that allow pressurized cavity 16 to either be supplied or vented to external sources. In an exemplary embodiment, high-speed pressurized impeller disk 10 comprises hub orifice 20 extending from pressurized cavity 16 through hub 12. Hub orifice 20 extends generally in radially inward direction RD2 from radially outward facing surface 62 to radially inward facing surface 72. In an exemplary embodiment, hub orifice 20 is arranged perpendicular to axis of rotation AX.

In an exemplary embodiment, high-speed pressurized impeller disk 10 comprises forward wall orifice 21 extending from pressurized cavity 16 through forward cavity wall 18. Forward wall orifice 21 extends from aft facing surface 52 to forward facing surface 50. In an exemplary embodiment, forward wall orifice 21 fluidly connects pressurized cavity 16 with vane 30. In an exemplary embodiment, forward wall orifice 21 extends radially outward (i.e., in radial direction RD1) in axial direction AD1 (shown as angled up and to the left in FIG. 3). In an exemplary embodiment, forward wall orifice 21 is arranged nonperpendicular and nonparallel to axis of rotation.

In an exemplary embodiment, high-speed pressurized impeller disk 10 comprises aft wall orifice 22 extending from pressurized cavity 16 through aft cavity wall 19. Aft wall orifice 22 extends from forward facing surface 40 to aft facing surface 42. In an exemplary embodiment, aft wall orifice 22 extends radially outward (i.e., in radial direction RD1) in axial direction AD2 (shown as angled down and to the left in FIG. 3). In an exemplary embodiment, aft wall orifice 22 is arranged nonperpendicular and nonparallel to axis of rotation.

In an exemplary embodiment, high-speed pressurized impeller disk 10 comprises impeller tip orifice 23 extending from pressurized cavity 16 through tip 15. Impeller tip orifice 23 extends from radially inward facing surface 60 to radially outward facing surface 80 formed by tip 15. In an exemplary embodiment, impeller tip orifice 23 is arranged perpendicular to axis of rotation AX.

Orifice location may be chosen depending on the desired pressure of pressurized cavity 16. For example, since the further the location radially outward along a radial axis (i.e., radial direction RD1) of impeller 10, the higher the velocity of the impeller is, this in turn results in a higher pressure supplied by the orifice. In this example, hub orifice 20 would provide the lowest pressure source, with forward wall orifice 21 and aft wall orifice 22 providing moderate pressure, and tip orifice 23 providing peak pressure.

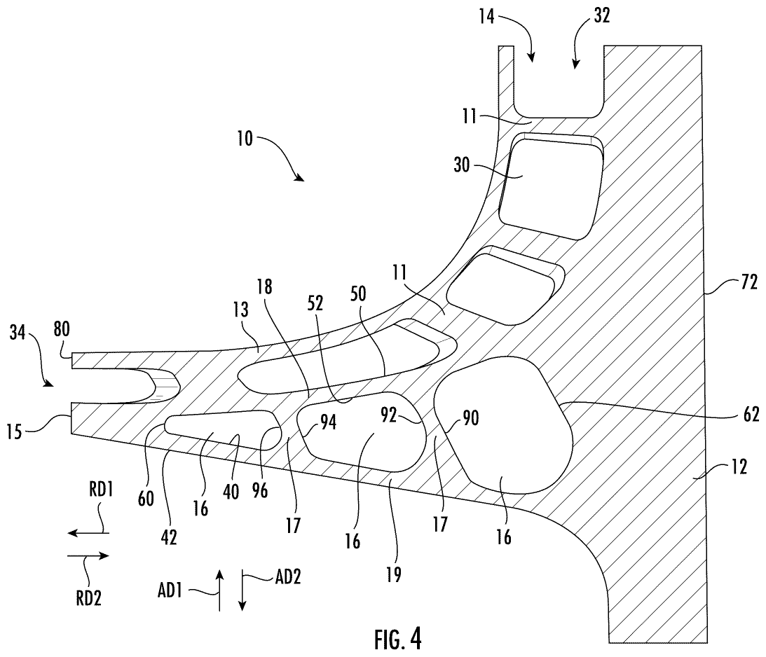

FIG. 4 is a cross-sectional view of high-speed pressurized impeller disk 10 shown in FIG. 1, in which an internal support structure directs the stresses within pressurized cavity 16 to specific regions. The embodied support structure utilizes one or more annular rings 17 to adjoin forward wall 18 and aft wall 19 of pressure cavity 16 at a constant radial position along each face, creating a circumferential box-like structure of the hollow passage. Annular rings 17 extend from forward facing surface 40 to aft facing surface 52. In an exemplary embodiment, at least one annular ring 17 of the one or more annular rings 17 extends radially outward (i.e., in radial direction RD1) in axial direction AD1 (shown as angled up and to the left in FIG. 3). Each annular ring 17 forms a radially inward facing surface 90, 94 and radially outward facing surface 92, 96.

In an exemplary embodiment, high-speed pressurized impeller disk 10 comprises a plurality of annular rings 17, for example, first annular ring 17 and second annular ring 17. First annular ring 17 extends through cavity 16 from aft cavity wall 19 to forward cavity wall 18 and forms radially inward facing surface 90 and radially outward facing surface 92. First annular ring 17 forms a first cavity section arranged radially between radially outward facing surface 62 and radially inward facing surface 90.

Second annular ring 17 extends through cavity 16 from aft cavity wall 19 to forward cavity wall 18 and forms radially inward facing surface 94 and radially outward facing surface 96. Second annular ring 17 forms a second cavity section arranged radially between radially outward facing surface 92 and radially inward facing surface 94, and a third cavity section arranged radially between radially outward facing surface 96 and radially inward facing surface 60. In an exemplary embodiment, the diameter of second annular ring 17 is less than the diameter of first annular ring 17.

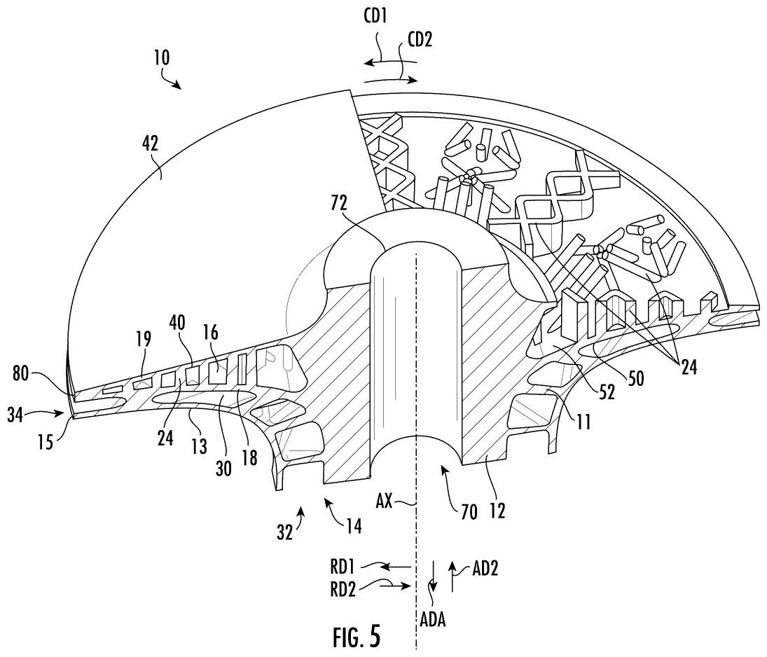

FIG. 5 is an isometric view of high-speed pressurized impeller disk 10 shown in FIG. 1, wherein the internal support structure for stress reduction is not functioning in an axisymmetric fashion and is a unique three-dimensional (3D) truss structure. In an exemplary embodiment, individual beams or baffles 24 adjoin forward wall 18 and aft wall 19 similar to annular rings 17, but with each beam or baffle 24 attaching at specific points on each wall or face circumferentially and not in a constant fashion. Beams or baffles 24 extend across cavity 16 between forward facing surface 40 and aft facing surface 52. This allows for a more pinpoint direction of stresses in the 3D space as opposed to a purely circumferential application. The beams act as a singular load path for transference of force, whereas the baffles act as a high aspect ratio beam following a continuous profile. Beams would be used for areas of very localized stress, such as those seen in the leading edge of a blade. Thus, in an exemplary embodiment, beam 24 is arranged in pressurized cavity 16 at or proximate to the leading edge of blade 11. Baffles would be used across continuous stress regions, such as those seen on the leeward side of the blade relative to rotation. Thus, in an exemplary embodiment, baffle 24 is arranged in pressurized cavity 16 at or proximate to the leeward side or trailing side of blade 11.

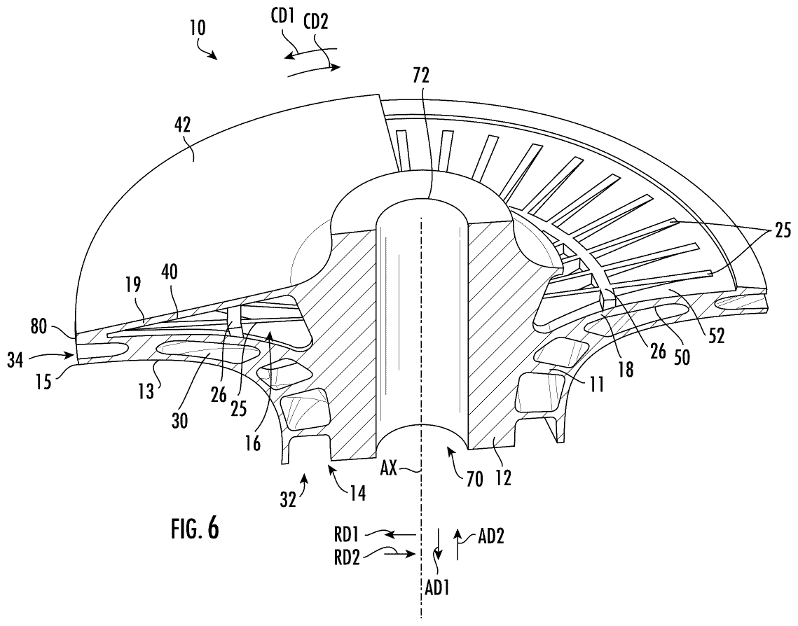

FIG. 6 is an isometric view of high-speed pressurized impeller disk 10 shown in FIG. 1 including one or more internal stiffening ribs. In an exemplary embodiment, the internal stiffening ribs include one or more radially extending stiffening ribs 25. Stiffening ribs 25 extend radially outward from hub 12 in radial direction RD1 and are circumferentially spaced apart along aft facing surface 52. In an exemplary embodiment, ribs 25 extend only partially to tip 15.

In an exemplary embodiment, the internal stiffening ribs include one or more tangential or circumferentially extending stiffening ribs 26. Stiffening rib 26 extends circumferentially (i.e., in circumferential direction CD1, CD2) along aft facing surface 52. In an exemplary embodiment, stiffening rib 26 is an annular rib extending completely around high-speed impeller disk 10. In an exemplary embodiment, stiffening rib 26 is arranged radially between and spaced apart from hub 12 and tip 15.

In an exemplary embodiment, ribs 25, 26 extend from aft facing surface 52 only partially to forward facing surface 40. That is to say, ribs 25, 26 may not be connected to forward facing surface 40, as shown in FIG. 6. In an exemplary embodiment, ribs 25, 26 extend from forward facing surface 40 only partially to aft facing surface 52. That is to say, ribs 25, 26 may not be connected to aft facing surface 52, as shown in FIG. 6. In an exemplary embodiment, ribs 25, 26 extend completely from aft facing surface 52 to forward facing surface 40.

In an exemplary embodiment, ribs 25, 26 may be arranged on both aft facing surface 52 and forward facing surface 40. These ribs, which are oriented radially, tangentially, or a combination of the two are used to stiffen each face or wall, for example forward cavity wall 18 and aft cavity wall 19, independently of one another. Ribs 25, 26 act to control the stress and deflection of an individual face or wall (e.g., forward cavity wall 18 and/or aft cavity wall 19) without shifting the strain energy to the opposite face. However, in specific scenarios as the design necessitates, ribs 25, 26 would adjoin the two faces or walls 18, 19.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

### REFERENCE NUMERALS

10 High-speed impeller disk
11 Blade
12 Hub
13 Shroud
14 Eye
15 Tip
16 Cavity
17 Annular ring or support structure
18 Forward cavity wall
19 Aft cavity wall
20 Hub orifice
21 Forward orifice
22 Aft orifice
23 Tip orifice
24 Beams or baffles
25 Stiffening rib
26 Stiffening rib
30 Vane
32 End
34 End
40 Forward facing surface
42 Aft facing surface
50 Forward facing surface
52 Aft facing surface
60 Radially inward facing surface
62 Radially outward facing surface
70 Hole or through-hole
72 Radially inward facing surface
80 Radially outward facing surface
90 Radially inward facing surface
92 Radially inward facing surface
94 Radially inward facing surface
96 Radially outward facing surface
AD1 Axial direction
AD2 Axial direction
AX Axis
CD1 Circumferential direction
CD2 Circumferential direction
RD1 Radial direction
RD2 Radial direction

What is claimed is

1. A pressurized impeller, comprising:
an axis of rotation;
a hub;
a forward wall including a first forward surface and a first aft surface;
an aft wall including a second forward surface and a second aft surface;
an axial opening;
a radial opening, wherein the axial opening and the radial opening are connected within the pressurized impeller to form a plurality of fluid flow paths; and
an internal pressurized cavity formed between the forward wall and the aft wall, wherein a first orifice opens into a tip of the pressurized impeller.

2. The pressurized impeller as recited in claim 1, wherein a second orifice opens into at least one of the hub, the forward wall, and the aft wall.

3. The pressurized impeller as recited in claim 1, further comprising one or more annular rings arranged in the internal pressurized cavity.

4. The pressurized impeller as recited in claim 3, wherein each ring of the one or more annular rings:
is arranged radially between and spaced apart from the tip and the hub; and
extends from the aft wall to the forward wall.

5. The pressurized impeller as recited in claim 3, wherein at least one ring of the annular ring is arranged nonparallel to the axis of rotation.

6. The pressurized impeller as recited in claim 1, further comprises at least one stiffening rib arranged on at least one of the first aft surface and the second forward surface.

7. The pressurized impeller as recited in claim 6, wherein the at least one stiffening rib extends in a radially outward direction relative to the hub.

8. The pressurized impeller as recited in claim 6, wherein the at least one stiffening rib extends in a circumferential direction around the hub.

9. A pressurized impeller, comprising:
a hub;
a forward wall including a first forward surface and a first aft surface;
an aft wall including a second forward surface and a second aft surface;
an axial opening;
a radial opening, wherein the axial opening and the radial opening are connected within the pressurized impeller to form a plurality of fluid flow paths; and
an internal pressurized cavity formed between the forward wall and the aft wall, wherein a first orifice opens into the hub.

10. The pressurized impeller as recited in claim 9, wherein a second orifice opens into at least one of the tip, the forward wall, and the aft wall.

11. The pressurized impeller as recited in claim 9, further comprising one or more annular rings arranged in the internal pressurized cavity.

12. The pressurized impeller as recited in claim 11, wherein each ring of the one or more annular rings:
is arranged radially between and spaced apart from the tip and the hub; and
extends from the aft wall to the forward wall.

13. The pressurized impeller as recited in claim 11, wherein at least one ring of the annular ring is arranged nonparallel to the axis of rotation.

14. The pressurized impeller as recited in claim 9, further comprises at least one stiffening rib arranged on at least one of the first aft surface and the second forward surface.

15. The pressurized impeller as recited in claim 14, wherein the at least one stiffening rib extends in a radially outward direction relative to the hub.

16. The pressurized impeller as recited in claim 14, wherein the at least one stiffening rib extends in a circumferential direction around the hub.

17. A pressurized impeller, comprising:
a hub;
a forward wall including a first forward surface and a first aft surface;
an aft wall including a second forward surface and a second aft surface;
an axial opening;
a radial opening, wherein the axial opening and the radial opening are connected within the pressurized impeller to form a plurality of fluid flow paths;
an internal pressurized cavity formed between the forward wall and the aft wall; and
a support structure arranged in the internal pressurized cavity.

18. The pressurized impeller as recited in claim 17, wherein the support structure comprises at least one stiffening rib arranged on at least one of the first aft surface and the second forward surface.

19. The pressurized impeller as recited in claim 18, wherein the at least one stiffening rib extends in:
a radially outward direction relative to the hub; or
a circumferential direction around the hub.

20. The pressurized impeller as recited in claim 17, wherein the support structure comprises a beam arranged on the first aft surface proximate a leading edge of a blade of the pressurized impeller.
